(19) United States
(12) Patent Application Publication
(10) Pub. No.: US 2011/0262594 A1
(43) Pub. Date: Oct. 27, 2011

(54) METHOD FOR THE PRODUCTION OF BREAD

(76) Inventors: Lin Cheong Carson, Zanesville, OH (US); Jennifer Kay Dale, Zanesville, OH (US)

(21) Appl. No.: 13/052,411

(22) Filed: Mar. 21, 2011

Related U.S. Application Data
(60) Provisional application No. 61/327,664, filed on Apr. 24, 2010.

(51) Int. Cl. A21D 8/04

(52) U.S. Cl. 426/62; 426/19

(57) ABSTRACT

A method for producing bread dough that when baked contains a porous crumb with larger air pockets comprising introducing a mechanical mixer, procuring dry components comprising flour and yeast, procuring liquid components comprising water, and mixing two or more portions of the liquid components with the dry components in two or more liquid mixing addition phases.

This patent application claims the benefit of U.S. Provisional Patent Application No. 61/327,664 filed Apr. 24, 2010.

### BACKGROUND OF THE INVENTION

The present invention relates to a method for the production of bread with a crumb that comprises larger air pockets resembling that of ciabatta-type bread. Ciabatta is an Italian white bread made with wheat flour and yeast. It is a handcrafted loaf consisting of a moist, porous interior with large air pockets, and a thin, crisp crust.

Ciabatta dough is unique in many ways. The dough is very wet and sticky, frequently with 80% or higher hydration. This elevated hydration requires special handling and lengthy fermentation periods which then produce the delicate pockets of air remaining in the crumb.

The traditional way of producing ciabatta bun by hand requires a long mixing time with more than three water-addition steps, a long bulk fermentation time, a stress-free environment to keep the large air pockets in the dough, and a long bake time in an oven that uses steam to make the buns crusty and shiny.

In recent years, due to an increase in demand for ciabatta bread and ciabatta buns, commercial bread-making equipment has been modified to mass produce ciabatta. This has resulted in the development of stress-free extruders and stress-free dough systems. These systems are costly and have relatively slow production rates.

For the foregoing reasons, there is a need for a method that produces a dough that when baked contains a porous interior containing larger air pockets that does not require slow, stress-free dough systems.

### SUMMARY OF THE INVENTION

It would therefore be desirable, and is an advantage of the present invention, to provide an efficient method of preparing a bread dough that when baked results in a bread that is much like ciabatta bread with a moist, porous crumb with larger air pockets.

A method according to the present invention for making bread dough comprising introducing a mechanical mixer, procuring liquid components comprising about 75-100 parts by weight of water per 100 parts by weight of flour, procuring dry components comprising flour and yeast, and mixing two or more portions of the liquid components in two or more liquid mixing addition phases.

In a particular embodiment of the invention, two liquid mixing addition phases are applied. A first liquid mixing phase comprises mixing dry components with a first portion of the liquid components for one or more periods of time at one or more mixing speeds, thereby producing an intermediate dough slurry; in a second liquid mixing addition phase, mixing the intermediate dough slurry with a second portion of the liquid components for one or more periods of time at one or more mixing speeds, thereby producing a homogeneous final dough product. The first portion of liquid components may be 50-80% of the liquid components and the second portion can be 20-50% of the liquid components.

In other embodiments, the method may be carried out by more than two liquid mixing addition phases. Applying more than two liquid mixing addition phases further improves and enlarges the desired porous crumb with larger air pockets. Thus, numerous liquid mixing addition phases may be exercised to achieve a baker's desired end product.

If desired, certain ingredients may be utilized and added to the dry components to further develop and produce the desired dough product that when baked contains a porous crumb with larger air pockets. For example, the addition of gluten aids in the overall strength of the resulting bread. The increased strength helps retain the gas in the dough, thus larger air pockets will result. Deactivated yeast may be used as a dough reducing agent. Deactivated yeast has chemical compounds that act on protein molecules which makes the dough more extensible. As such, improving the size of the developed large air pockets within the dough. Ascorbic acid may also be used as a dough oxidizing agent. Ascorbic acid chemically reacts with other ingredients, making the dough stronger.

### DETAILED DESCRIPTION OF THE INVENTION

In order to explain the invention, this description first presents some background material relating to the art of the production of bread.

As used herein, parts are parts by weight and percents are weight percents unless otherwise indicated or apparent. When a preferred range such as 5-25 is given, this means preferably at least 5 and preferably not more than 25.

The method of the present invention utilizes a mixer and other culinary implements to produce a bread from a dough comprised of three basic components: flour, yeast, and water. The liquid components comprise water and the dry components comprise flour and yeast. The dry components may further include salt, sugar, soy oil, gluten, deactivated yeast, and ascorbic acid and any other known ingredients for making bread. Other ingredients may be added to suit a particular baker's taste.

Flour derived from wheat berries contains proteins, which are converted to gluten when a liquid is added. The gluten is further developed during the mixing or kneading procedure. The flour may be bread flour, all-purpose flour, whole wheat flour, or any other desired type of flour having a sufficiently high gluten content. Blends of different types of flours may also be used. The particular type of flour selected is determined by the bread properties desired by a particular baker. Preferably the flour is a bread flour with no less than 11% protein.

The yeast ferments sugars in dough to produce carbon dioxide, which causes the dough to rise. The yeast may be instant yeast, active dry yeast, or compressed yeast, or a combination thereof. Instead of or in addition to adding yeast directly, the yeast can be provided in a mixture called a brew. This is a blend of compressed yeast, sugar, and water that has fermented. The starter develops active yeast organisms. Preferably, the yeast in an embodiment is compressed yeast.

Particular embodiments of the invention may utilize the addition of gluten, deactivated yeast, and ascorbic acid individually or in combination to assist in the development of ciabatta like bread comprising larger air pockets. However, these ingredients are not essential to the functional part of the inventive concept. The addition of gluten assists in the overall strength of the resulting bread. The increased strength helps retain the gas in the dough, thus larger air pockets will result. Deactivated yeast may be used as a dough reducing agent. Deactivated yeast has chemical compounds that act on protein molecules which makes the dough more extensible. As such, improving the size of the developed large air pockets within the dough. Ascorbic acid may also be used as a dough oxidizing agent. Ascorbic acid chemically reacts with other ingredients, making the dough stronger.

The water in the dough moistens the flour, hydrating the proteins and carbohydrates for dough development. In addition, water dilutes the protein network and enables the large air pockets to develop in the dough, and it maintains the temperature of the dough.

Additional ingredients may be added as flavor components; however, they are not part of the functional part of the inventive concept.

The addition of sugar is not considered an essential ingredient to the functional part of the inventive concept. However, if desired, sugar may be added. Sugar provides added sweetness, helps to produce a golden brown color of the crust, and improves the texture of the crumb. It also helps to retain moisture in the crumb and adds to the nutritional value of the bread. Sugar may be granulated sugar, sucrose, dextrose, or any other sugar suitable for baking a yeast-leavened bread product. For example, any corn syrups having glucose, maltose, fructose, maltodextrins, dextrins, and/or oligo saccharides may be employed.

In addition, salt may be added if desired. The addition of salt is not an essential ingredient to the functional part of the inventive concept. Salt provides flavor to the dough, enhances the taste of flour, contributes to the color of the bread, and keeps the yeast from growing too quickly. The salt may be table salt, fine sea salt, kosher salt, or pickling salt. Preferably, the salt in an embodiment is table salt, which can be replaced by a suitable substitute.

To form a dough from flour and water, any known means can be employed without limitation, so far as both are mixed to form a substantially homogeneous dough. Specifically, the mixture of the water, flour, yeast, and additional ingredients can be mixed by a mechanical mixer, more particularly an electric mixer or an industrial mixer. Preferably, an industrial mixer is used as is well known in the art of the mass production of bread. Alternatively, the mixer can be any electric mixer known to those of skill in the art. The mixer mixes the dough ingredients in a conventional fashion as is well known in the art.

It will be mentioned that mechanical mixers vary in dimension, speed, and power. Naturally, required mixer speeds and mix periods of time will vary with different mixers to produce the same desired end product. Thus, mixer speeds and mix periods of time shall not be limited to the examples given.

In an embodiment, a suitable selection for the electric mixer is preferably a spiral stand mixer with a variable speed motor such as the Hobart Legacy HL120. Several other mixers have variable speed operation, lower speed being around 100 RPM and the higher speed being around 200 RPM.

In another embodiment, the invention is more particularly suited for blending of ingredients by an industrial dough mixer customarily used for the mass production of bread such as a Baker-Perkins 920 industrial-type mixer. By way of background, most large commercial high-speed dough mixers operate at two speeds during the mixing operation. A low speed, which is nominally one-half of the high speed, is used initially to blend the ingredients after they have been loaded into the mixer. It is desirable to utilize a low mixer speed for the preliminary blending of ingredients so that they may be brought to a condition favorable for subsequent mixing and development. A high speed is then utilized during the balance of the mixing time in order to obtain final development of the dough. In actual operation, the machine starts at a low speed for a short period of time and is caused to automatically shift into high speed for the duration of the mixing operation. The mixer mixes a bulk quantity of dough by mixing the flour, water, yeast, and other selected ingredients.

The method according to the present invention for making bread dough comprises introducing a mechanical mixer, procuring liquid components comprising about 75-100 parts by weight of water per 100 parts by weight of flour, procuring dry components comprising flour and yeast, and mixing two or more portions of the liquid components in two or more liquid mixing addition phases.

The inventive concept comprises two or more liquid mixing addition phases. The number of portions of the liquid components is determined by the desired number of liquid mixing addition phases. Each liquid mixing addition phase comprises mixing a portion of the liquid components. For example, if five liquid mixing addition phases are desired, five portions of the liquid components are determined and mixed in a separate liquid mixing addition phase.

In a first embodiment of the invention, two liquid mixing addition phases are applied. An electric mixer is preferably used. The liquid components comprise water which is preferably 75-100 parts, more preferably 75-85 parts. A first portion of the liquid components is selected to be preferably 50-80% of the liquid components, more preferably about 75% of the liquid components. A second portion of the liquid components is selected to be preferably about 20-50% of the liquid components, more preferably about 25% of the liquid components. The dry components preferably comprise 100 parts of flour and a sufficient amount of yeast for proper fermentation, preferably about 1-3 parts dry yeast, more preferably 2 parts. Optionally, but preferably the dry components may further comprise about 5-7 parts high fructose corn syrup; about 1-3 parts of table salt; 0.1-5 parts gluten, more preferably 0.5 parts; 0.1-5 parts deactivated yeast, more preferably 2 parts; about 0.01-1 parts ascorbic acid, more preferably 0.05 parts; and about 1 part soy oil.

In a first liquid mixing addition phase, the dry components comprising flour, yeast, and optional additional ingredients are added to the mixing container of the mixer. The first portion of the liquid components is added to the mixing container with the dry components. The mixer is then turned on at a lower mixer speed for a first mix period of time for the preliminary blending of ingredients so that they may be brought to a condition favorable for a higher mixer speed and development. The mixer is then turned on the higher mixer speed for a second mix period of time sufficient to create an intermediate dough slurry.

In a second liquid mixing addition phase, the second portion of the liquid components is added to the intermediate dough slurry remaining in the mixing container, which can vary from 20-50% of the liquid components. The mixer is then turned on a lower mixer speed for a third mix period of time sufficient for preliminary blending of ingredients. The mixer is then turned on a higher mixer speed for a fourth mix period of time sufficient to form a substantially homogeneous final dough product.

More particularly, as an example, utilizing the Hobart Legacy HL120 spiral stand mixer with a variable speed motor, the lower mixer speed is about 107 RPM and the higher mixer speed (Intermediate) is about 198 RPM. In the first liquid mixing addition phase, the first mix period of time is preferably 0.5-1.5 minutes, more preferably about 1 minute and the second mix period of time is preferably 4-8 minutes, more preferably about 5 minutes. In the second liquid mixing addition phase, the third mix period of time is about 1-3 minutes, more preferably about 2 minutes and the fourth mix period of time is preferably about 8-14 minutes, more preferably about 11 minutes.

In an alternative embodiment of the present invention, an industrial dough mixer is preferably used. The water is preferably 75-100 parts, more preferably 80 parts. A first portion of the liquid components is selected to be preferably 50-80% of the liquid components, more preferably about 75% of the liquid components. A second portion of the liquid components is selected to be preferably about 20-50% of the liquid components, preferably about 25% of the liquid components. The dry components preferably comprise 100 parts of flour and a sufficient amount of yeast for proper fermentation, preferably about 2 parts dry yeast. Optionally, the dry components may further comprise about 5-7 parts granulated sugar, more preferably 6 parts; about 1-3 parts of salt; 0.1-5 parts gluten, more preferably 0.5 parts; 0.1-5 parts deactivated yeast, more preferably 2 parts; and about 0.01-1 parts ascorbic acid, more preferably 0.05 parts.

In a first liquid mixing addition phase, the dry components comprising the flour, yeast, and other optional additional ingredients are added to the mixing container of the mixer. The first portion of the liquid components is added to the mixing container with the dry components. The mixer is then turned on at a lower mixing speed for a first mix period of time for the preliminary blending of ingredients so that they may be brought to a condition favorable for a higher mixer speed and development. The mixer is then turned on the higher mixer speed for a second mix period of time sufficient to create an intermediate dough slurry.

In a second liquid mixing addition phase, the second portion of the liquid components is added to the intermediate dough slurry remaining in the mixing container, which can vary from 20-50% of the liquid components. The mixer is then turned on a lower mixer speed for a third mix period of time for the preliminary blending of ingredients. The mixer is then turned on a higher mixer speed for a fourth mix period of time sufficient to create a substantially homogeneous final dough product.

More particularly, as an example, utilizing a Baker-Perkins 920 industrial-type mixer, the lower mixer speed is about 35 RPM and the higher mixer speed is about 70 RPM. In the first liquid mixing addition phase, the first mix period of time is preferably 0.5-1.5 minutes, more preferably about 1 minute and the second mix period of time is preferably 5-8 minutes, more preferably about 6 minutes. In the second liquid mixing addition phase, the third mix period of time is about 0.5-1.5 minutes, more preferably 1 minute and the fourth mix period of time is preferably 3-6 minutes, more preferably about 4 minutes.

In yet another alternative embodiment of the present invention, the method is carried out by more than two liquid mixing addition phases, more particularly three phases. Preferably a mechanical mixer is used. The liquid components comprise 75-100 parts of water, more preferably 80 parts. A first portion of the liquid components is selected to be preferably 50-80% of the liquid components, more preferably about 70%. A second portion of the liquid components is selected to be preferably about 10-30% of the liquid components, preferably about 20% of the liquid components. A third portion of the liquid components is selected to be preferably about 5-15% of the liquid components, preferably about 10% of the liquid components. The dry components preferably comprise 100 parts of flour and a sufficient amount of yeast for proper fermentation, preferably 2 parts dry yeast. Optionally, the dry components may further comprise 0.1-5 parts gluten, more preferably 0.5 parts; 0.1-5 parts deactivated yeast, more preferably 2 parts; and about 0.01-1 parts ascorbic acid, more preferably 0.05 parts.

In a first liquid mixing addition phase, the dry components comprising flour, yeast, and optional additional ingredients are added to the mixing container of the mixer. The first portion of the liquid components is added to the mixing container with the dry components. The mixer is then turned on at a lower mixer speed for a first mix period of time for the preliminary blending of ingredients so that they may be brought to a condition favorable for a higher mixer speed and development. The mixer is then turned on a higher mixer speed for a second mix period of time sufficient to create an intermediate dough slurry.

In a second liquid mixing addition phase, the second portion of the liquid components is added to the intermediate dough slurry remaining in the mixing container, which is preferably 10-30% of the liquid components. The mixer is then turned on for one or more mix speeds at one or more mix periods of time, thereby creating a second intermediate dough slurry.

In a third liquid mixing addition phase, the third portion of the liquid components is added to the second intermediate dough slurry remaining in the mixing container, which is preferably 5-15% of the liquid components. The mixer is then turned on for one or more mix speeds at one or more mix periods of time sufficient to form a substantially homogenous final dough product.

The method steps described hereafter are not a necessary part of the inventive concept. However, these steps may be used for final processing of the dough product produced in the above embodiments.

After the dough has been mixed, it is transferred from the mixing container and is then formed into dough patties. In a commercial bakery, the dough may be piped to a mechanical device such as an extruder that divides and cuts the dough into specific portions and placed directly onto baking pans. More particularly, an extruder may be utilized to cut and dispense dough into dough patties for the purpose of forming ciabatta buns. The extruder may be any extruder known to those of skill in the art. The dough may also be transferred to other devices for further forming of the dough into shapes for baking. Optionally, fermented and formed dough can be frozen and stored.

Once formed, the dough may be proofed. Proofing, as is well known in the art, ferments the raw dough shape or product. That is, proofing allows the yeast to produce carbon dioxide from the sugar. This begins the chemical process of leavening that makes the raw dough expand and also improves the taste of the raw dough. Proofing may be carried out for about 20-60 minutes at about 90°-105° F. under conditions of about 75-90% relative humidity. It is preferred that the proofing be carried out for from about 40 minutes at about 95°-100° F. and at about 80-85% relative humidity.

The proofed dough then is transferred to an oven to bake for a baking period of time until crusts of the bread are golden brown at an oven temperature preferably in a range of about 425-475° F., more preferably about 450° F. Preferably, the baking period of time is about 10-20 minutes, more preferably about 15 minutes.

After the dough has been baked, the bread product is thereafter conveyed to a depanning device. In general, the depanning device may be any device that is adapted to lift or remove the dough products from their pans.

After depanning, the bread product may be glazed. Glazing may be carried out by any known means that is recognized by those skilled in the art.

After glazing, the bread product is allowed to cool. Cooling may be carried out by any known means that is recognized by those skilled in the art. Preferably, the bread product is allowed to cool on a conveyor belt.

After cooling, the bread product may be packaged and trayed. Packaging of bread product may be carried out by any known means that is recognized by those skilled in the art.

Optionally, the bread product of the present invention can be conveyed to a freezer, which freezes the bread product. Once frozen, the bread product may remain frozen for a substantial period of time.

The following Examples further illustrate various aspects of the invention. Unless otherwise indicated, the components are combined using methods known in the art or as described above.

### EXAMPLE I

Bread was prepared in accordance with the present invention by selecting 2 lbs of bread flour, 0.12 lbs of high-fructose corn syrup, 0.04 lbs of table salt, 0.04 lbs of dry yeast, 0.04 lbs of deactivated yeast, 0.02 lbs of soy oil, 0.01 lbs of gluten, 0.001 lbs of ascorbic acid, and 1.6 lbs of water. The flour, high-fructose corn syrup, table salt, dry yeast, deactivated yeast, soy oil, gluten, and ascorbic acid were added to the bowl of a Hobart Legacy HL120 mixer equipped with a metal cutting blade. The mixer was turned on and 75% of the water was added to the mixing bowl. The mixer was allowed to run on low for 1 minute and then on intermediate for 5 minutes. The remaining 25% of the water was then added to the bowl. The mixer was allowed to run on low for two minutes and then on intermediate for 11 minutes. The dough was then formed into 3-ounce dough patties, which were placed into 4-inch square, 1-inch deep pans. The patties were then proofed at 105° F. for about 40 minutes. The patties were baked at 425° F. for about 15 minutes. The bread produced in this example had a moist, porous crumb, a nice brown top, and a rich, full taste.

### EXAMPLE II

Bread was prepared in accordance with the present invention by selecting 750 lbs of bread flour, 15 lbs of granulated sugar, 15 lbs of table salt, 15 lbs of dry yeast, 15 lbs of deactivated yeast, 7.5 lbs of soy oil, 3.75 lbs of gluten, 0.375 lbs of ascorbic acid, and 600 lbs of water. The flour, sugar, table salt, dry yeast, deactivated yeast, soy oil, gluten, and ascorbic acid were added to the mixing bowl of a Baker-Perkins 920 industrial-type mixer. The mixer was turned on and 80% of the water was added to the mixing bowl. The mixer was allowed to run on low for 1 minute and then on high for 6 minutes. The remaining 20% of the water was then added to the bowl. The mixer was allowed to run on low for 1 minute and then on high for 4 minutes. The dough was then formed into 3-ounce dough patties, which were placed into 4-inch square, 1-inch deep pans. The patties were then proofed at 105° F. for about 40 minutes. The patties were baked at 425° F. for about 15 minutes. The bread produced in this example had a moist, porous crumb, a nice brown top, and a rich, full taste.

### EXAMPLE III

Bread was prepared in accordance with the present invention by selecting 750 lbs of bread flour, 15 lbs of granulated sugar, 15 lbs of table salt, 15 lbs of dry yeast, 15 lbs of deactivated yeast, 7.5 lbs of soy oil, 3.75 lbs of gluten, 0.375 lbs of ascorbic acid, and 600 lbs of water. The flour, sugar, table salt, dry yeast, deactivated yeast, soy oil, gluten, and ascorbic acid were added to the mixing bowl of a Baker-Perkins 920 industrial-type mixer. The mixer was turned on and 75% of the water was added to the mixing bowl. The mixer was allowed to run on low for 1 minute and then on high for 3 minutes. The remaining 25% of the water was then added to the bowl. The mixer was allowed to run on low for 1 minute and then on high for 7 minutes. The dough was then formed into 3-ounce dough patties, which were placed into 4-inch square, 1-inch deep pans. The patties were then proofed at 105° F. for about 40 minutes. The patties were baked at 425° F. for about 15 minutes. The bread produced in this example had a moist, porous crumb, a nice brown top, and a rich, full taste.

It will be understood that various changes and modifications may be made in the above described method which provides the characteristics of the invention without departing from the spirit of the invention.

What is claimed is:

1. A method for making bread dough comprising the steps of:
introducing a mechanical mixer,
procuring dry components comprising flour and yeast,
procuring liquid components comprising 75-100 parts by weight of water to 100 parts by weight of the flour, and
mixing two or more portions of the liquid components with the dry components in two or more liquid mixing addition phases.

2. The method as recited in claim 1, comprising:
in a first liquid mixing addition phase, mixing dry components with a first portion of the liquid components for one or more periods of time at one or more mixing speeds, thereby producing an intermediate dough slurry;
in a second liquid mixing addition phase, mixing the intermediate dough slurry with a second portion of the liquid components for one or more periods of time at one or more mixing speeds, thereby producing a homogeneous final dough product.

3. The method as recited in claim 2, wherein the first portion of liquid components is 50-80% of the liquid components and the second portion of liquid components is 20-50% of the liquid components.

4. The method as recited in claim 3, wherein the dry components further comprise 0.1-5 parts gluten per 100 parts of the flour selected.

5. The method as recited in claim 3, wherein the dry components further comprise 0.1-5 parts deactivated yeast per 100 parts of the flour selected.

6. The method as recited in claim 3, wherein the dry components further comprise about 0.01-1 parts ascorbic acid per 100 parts of the flour selected.

7. The method as recited in claim 2, comprising:
in the first liquid mixing addition phase, mixing dry components with the first portion of the liquid components for a first mix period of time at a mixing speed sufficient for preliminary blending of ingredients;
increasing the mixing speed for a second period of time sufficient to develop the blended ingredients into an intermediate dough slurry;
in the second liquid mixing addition phase, mixing the intermediate dough slurry with the second portion of liquid components for a third mix period of time at a mixing speed sufficient for preliminary blending of remaining ingredients;
increasing the mixing speed for a fourth period of time sufficient to develop the blended ingredients into a homogeneous final dough product.

8. The method as recited in claim 7, wherein the first portion of liquid components is 50-80% of the liquid components and the second portion of liquid components is 20-50% of the liquid components.

9. The method as recited in claim 8, wherein the dry components further comprise 0.1-5 parts gluten per 100 parts of the flour selected.

10. The method as recited in claim 8, wherein the dry components further comprise 0.1-5 parts deactivated yeast per 100 parts of the flour selected.

11. The method as recited in claim 8, wherein the dry components further comprise about 0.01-1 parts ascorbic acid per 100 parts of the flour selected.

12. The method as recited in claim 1, wherein the dry components further comprise about 0.1-5 parts gluten per 100 parts of the flour selected.

13. The method as recited in claim 12, wherein the dry components further comprise 0.1-5 parts deactivated yeast per 100 parts of the flour selected.

14. The method as recited in claim 13, wherein the dry components further comprise 0.01-1 parts ascorbic acid per 100 parts of the flour selected.

15. The method as recited in claim 1, wherein the dry components further comprise 0.1-5 parts deactivated yeast per 100 parts of the flour selected.

16. The method as recited in claim 1, wherein the dry components further comprise about 0.01-1 parts ascorbic acid.

17. A method for making bread dough comprising the steps of:
introducing an industrial mixer suited for the mass production of bread;
procuring dry components comprising flour and yeast;
procuring liquid components comprising 75-100 parts of water per 100 parts flour selected;
in a first liquid mixing addition phase, mixing 50-80% by part of liquid components for a first mix period of time at a mixing speed sufficient for preliminary mixing of ingredients;
increasing the mixing speed for a second mix period of time thereby developing blended ingredients into an intermediate dough slurry;
in a second liquid mixing addition phase, mixing the intermediate dough slurry with 20-50% by part of liquid components for a third mix period of time at a mixing speed sufficient for preliminary blending of remaining ingredients;
increasing the mixing speed for a fourth mix period of time thereby developing the blended ingredients into a homogeneous final dough product.

18. The method recited in claim 17, wherein the dry components further comprise 0.3-0.7 parts gluten.

19. The method recited in claim 17, wherein the dry components further comprise 1-3 parts deactivated yeast.

20. The method recited in claim 17, wherein the dry components further comprise about 0.01-1 parts ascorbic acid.

21. A dough composition comprising flour, yeast, 75-100 parts water, 0.1-5 parts gluten, 0.1-5 parts deactivated yeast, and 0.01-1 parts ascorbic acid.
